(19) United States
(12) Patent Application Publication
(10) Pub. No.: US 2012/0114941 A1
(43) Pub. Date: May 10, 2012

(54) SYNTHESIS METHOD OF GRAPHITIC SHELL-ALLOY CORE HETEROSTRUCTURE NANOWIRES AND LONGITUDINAL METAL OXIDE HETEROSTRUCTURE NANOWIRES, AND REVERSIBLE SYNTHESIS METHOD BETWEEN NANOWIRES THEREOF

(75) Inventors: Nam Jo Jeong, Daejeon (KR); Jeong Gu Yeo, Daejeon (KR); Dong Kook Kim, Daejeon (KR)

(73) Assignee: KOREA INSTITUTE OF ENERGY RESEARCH, Daejeon (KR)

(21) Appl. No.: 13/288,441

(22) Filed: Nov. 3, 2011

(30) Foreign Application Priority Data
Nov. 8, 2010 (KR) 10-2010-0110445
Nov. 8, 2010 (KR) 10-2010-0110446

(51) Int. Cl. D02G 3/00; B05D 5/12; B82B 3/00; B82Y 99/00

(52) U.S. Cl. 428/373; 427/117; 977/843; 977/734

(57) ABSTRACT

A synthesis method containing core-shell heterostructure nanowires (or lateral heterostructure nanowires) surrounding alloy in shell and longitudinal metal oxide heterostructure nanowires, and a reversible synthesis method thereof are provided. According to the present invention, core-shell heterostructure nanowires and longitudinal metal oxide nanowires comprised of various substances using the simple process can be produced in volume.

### CROSS REFERENCE TO RELATED APPLICATION

This application claims the benefit under 35 U.S.C. 119(a) of Korean Patent Application No. 10-2010-0110445, filed on Nov. 8, 2010, and Korean Patent to Application No. 10-2010-0110446, filed on Nov. 8, 2010, the disclosure of each of which is incorporated by reference in its entirety for all purposes.

### BACKGROUND

1. Technical Field

The present invention relates to a method for synthesizing heterostructure nanowires that at least two kinds of substances are formed in the lateral and longitudinal directions.

In more particular, the present invention is to provide an improved method that can synthesize the heterostructure nanowires formed in a lateral and longitudinal. In addition, the present invention is to provide a synthesis method that a reversible change can be made between a lateral heterostructure and a longitudinal heterostructure.

2. Background Art

Carbon nanotubes have very superior properties in the various fields of physics, machinery, chemistry and electricity and the like and can achieve very enhanced properties by combining intermetallics or alloys with CNTs.

Encapsulation of materials sensitive to environmental factors (chemical reaction, oxidation, and mechanical vulnerability) in CNT can lead the formation of new materials with more stabilized and enhanced properties, and thus heterostructure nanowires may be applied to various fields.

Heterostructure nanowires which are one-dimension nanostructure involving CNTs are typically synthesized by vapor-liquid-solid mechanism. A heterostructure nanowire is grown by absorbing and diffusing sources for nanowire growth at high temperature and therefore CNTs is formed in shell type while nanowire is grown. It is advantageous that such a synthesis method makes the heterostructure to be uniform and the control of constituent components to be easy. But it is undesirable in that this method enables the process to be complex and mass production difficult.

Another formation method of core-shell heterostructure may be accomplished by opening chemically both ends of as-synthesized CNT and then pouring new core materials into inner portion of the CNT thereof through capillary action. However, such a method provides undesirable economic efficiency and has a complex process.

A longitudinal heterostructure nanowire which is another type of heteronanowires is synthesized by a vapor-liquid-solid mechanism. In synthesis method, nano-sized catalyst particles are used, which play a role in absorbing and diffusing sources for nanowire growth.

An important feature of this synthesis method is that catalyst forms longitudinal heterostructure nanowires using gases supplied alternatively.

The above-mentioned synthesis method has advantages in that a heterostructure is uniform and control of constituent components is easy, whereas this invention has disadvantages in that process is complex and a metal should be treated above the melting point because the necessary source should be provided as gaseous phase to synthesize the heterostructure nanowires for metal, preferably, metal oxide thereby causing the problems that the energy consumption increase and a mass production is not easy in view of a characteristics of the process.

### SUMMARY OF THE DISCLOSURE

To resolve the above noted problems, the object of the present invention is to provide a method that lateral heterostructure nanowires having graphitic shell and alloy core can be synthesized using a simple chemical vapor deposition (CVD).

In addition, the object of the present invention is to provide a method that the lateral heterotructure nanowire is oxidized to remove a graphitic shell and an alloy remained in the inner portion thereof is oxidized and separated to synthesize a longitudinal hetero nanowire.

Furthermore, the object of the present invention is to provide a reversible synthetic method that the lateral heterostructure nanowires and the longitudinal heterostructure nanowires can be converted each other.

The present invention to achieve the above noted object provides a synthesis method of lateral heterostructure nanowires containing alloy core and graphitic shell, wherein, the method comprises:

i) a step for preparing an metal oxide mixture, installing it into an reactor, and supplying an carrier gas under a vacuum atmosphere to increase the internal temperature of the reactor to the synthesis temperature; and

ii) a step for supplying hydrocarbon gases into the reactor and reacting the gas with the metal oxide mixture.

In addition, the present invention to achieve the above noted object provides a synthesis method of longitudinal metal oxide heterostructure nanowire, wherein the method comprises:

i) a step for preparing an metal oxide mixture, installing it into an reactor, and supplying an carrier gas under a vacuum atmosphere to increase the internal temperature of a reactor to an synthesis temperature;

ii) a step for supplying hydrocarbon gases into the reactor and reacting the gases with the metal oxide mixture to synthesize lateral heterostructure nanowires containing an alloy core and graphitic shell; and

iii) a step for after cooling the reactor to a room temperature, and increasing again the temperature under an air atmosphere to oxidize the lateral heterostructure nanowires.

Furthermore, the present invention to achieve the above noted object provides a reversible synthesis method between graphitic shell-alloy core heterostructure nanowires and longitudinal metal oxide heterostructure nanowires, the method comprising:

i) a step for reacting metal oxide mixture and hydrocarbon gases within a reactor to synthesize lateral heterostructure nanowires having alloy core and graphitic shell; and

ii) a step for oxidizing the lateral heterostructure nanowires of the synthesized core-shell to synthesis longitudinal metal oxide heterostructure nanowires, and

the step l) and ii) are performed repeatedly.

In this case, the metal oxide mixture is the mixture of indium oxide and tin oxide and is preferably 6:1˜1:6 based on weight rate, hydrocarbon gas flowing into the reactor is one and two more mixture selected from acetylene, ethylene and methane, and the amount of hydrocarbon flowing into the reactor is preferably in the range of 2˜10 vol %.

In addition, a hydrogen gas may be flowed to assist the reaction of metal oxide mixture with hydrocarbon, and the inflow amount of the hydrogen is preferably less than 5 vol % based on a carrier gas. Furthermore, the reaction temperature of the metal oxide mixture and hydrocarbon is controlled in the range of 550˜850° C. and the reaction time is preferably within 2 hours.

Moreover, the oxidation processing temperature of the graphitic shell-alloy core heterostructure nanowires is controlled in the range of 350˜650° C. The oxidation processing time of the graphitic shell-alloy core heterostructure nanowires is preferably in the range of 1 minute˜6 hours, and the temperature rise for oxidation process of the graphitic shell-alloy core heterostructure nanowires is preferably made in the range of 1˜10° C./min.

Furthermore, the metal oxide mixture may a mixture of bismuth oxide and tin oxide and the alloy may intermetallics.

On the other hand, graphitic shell-alloy core heterostructure nanowires synthesized using the method have superconducting critical temperature (Tc) at 4.8˜6.0 K, the outer diameter is in 50˜150 nm. the thickness of graphitic shell is 1˜20 nm, the length thereof is formed at 100 nm˜10 μm and the inner portion of graphitic shell of the heterostructure nanowire is filled with intermetallic core more than 90%.

In addition, the longitudinal metal oxide heterostructure nanowires synthesized using the method can be of a shape that indium/tin oxide (ITO) containing tin of 0.01˜10% relative to indium oxide and tin oxide is formed alternatively longitudinally, and the average diameter thereof is formed at 50˜150 nm, the length is formed at 100 nm˜10 μm.

### BRIEF DESCRIPTION OF THE DRAWINGS

FIG. 1 is a flowchart showing the synthesis method of graphitic shell-alloy core heterostructure nanowires and longitudinal metal oxide heterostructure nanowires and the reversible synthesis method thereof.

FIG. 2 shows XRD graph for lateral heterostructure nanowires having indium/tin intermetallic core and graphitic shell in accordance with the present application.

FIG. 3 shows SEM image according to the synthesis temperature of lateral heterostructure nanowires having indium/tin intermetallic core and graphitic shell in accordance with the present application.

FIG. 4 shows SEM image according to synthesis time of lateral heterostructure nanowires having indium/tin intermetallic core and graphitic shell in accordance with the present application.

FIG. 5 shows TEM image according to the synthesis time of lateral heterostructure nanowires having indium/tin intermetallic core and graphitic shell in accordance with the present application.

FIG. 6 shows the element analysis of heterostructure nanowires having indium/tin intermetallic core and graphitic shell in accordance with the present application.

FIG. 7 shows XRD graph for longitudinal ITO-tin oxide heterostructure nanowires.

FIG. 8 shows SEM image for longitudinal ITO-tin oxide heterostructure nanowires obtained using oxidation process of lateral heterostructure nanowires having indium/tin core and graphitic shell in accordance with the present invention.

FIG. 9 shows TEM image for a longitudinal ITO-tin oxide heterostructure nanowires.

FIG. 10 shows the line element profile of longitudinal ITO-tin oxide heterostructure nanowires.

FIG. 11 shows Mapping image for longitudinal ITO-tin oxide heterostructure nanowires.

FIG. 12 show In-situ XRD analysis of longitudinal ITO-tin oxide heterostructure nanowires finally obtained using oxidation process of lateral heterostructure nanowires having indium/tin core and graphitic shell in accordance with the present invention.

FIG. 13 shows In-situ Raman analysis of longitudinal ITO-tin oxide heterostructure nanowires finally obtained using oxidation process of lateral heterostructure nanowires having indium/tin core and graphitic shell in accordance with the present invention.

FIG. 14 shows the result of superconducting properties analysis of lateral heterostructure nanowires having indium/tin core and graphitic shell in accordance with the present invention.

FIG. 15 shows lateral heterostructure nanowires having bismuth/tin core and graphitic shell synthesized in the same manner as the present invention.

FIG. 16 shows measurement result of CL (cathodoluminescence) of longitudinal ITO-tin oxide heterostructure nanowires.

FIG. 17 shows SEM image for reversible synthesis to lateral heterostructure nanowires having indium/tin core and graphitic shell of longitudinal ITO-tin oxide heterostructure nanowires.

### DETAILED DESCRIPTION

As described below, the synthesis method of graphitic shell-alloy core heterostructure nanowires and longitudinal metal oxide heterostructure nanowires and a reversible synthesis method thereof in the invention will described with reference to the accompanying drawings.

The present invention to achieve the above noted object provides a synthesis method of lateral heterostructure nanowires containing alloy core and graphitic shell, wherein,

the method comprises:

i) a step for preparing an metal oxide mixture, installing it into an reactor, and supplying an carrier gas under a vacuum atmosphere to increase the internal temperature of the reactor to the synthesis temperature; and

ii) a step for supplying hydrocarbon gases into the reactor and reacting the gas with the metal oxide mixture.

In addition, the present invention to achieve the above noted object provides a synthesis method of longitudinal metal oxide heterostructure nanowires, wherein

the method comprises:

i) a step for preparing an metal oxide mixture, supplying it into an reactor, and supplying an carrier gas under a vacuum atmosphere to increase the internal temperature of a reactor to an synthesis temperature;

ii) a step for supplying the hydrocarbon gases into the reactor and reacting the gases with the metal oxide mixture to synthesize lateral heterostructure nanowires containing an alloy core and carbon graphitic shell; and

iii) a step for after cooling the reactor to a room temperature, and increasing again the temperature under a oxide atmosphere to oxidize the lateral heterostructure nanowires.

Furthermore, the present invention to achieve the above noted object provides a reversible synthesis method between graphitic shell-alloy core heterostructure nanowires and longitudinal metal oxide heterostructure nanowires, wherein the method comprises:

i) a step for reacting metal oxide mixture and hydrocarbon gases within a reactor to synthesize lateral heterostructure nanowires having alloy core and graphitic shell; and

ii) a step for oxidizing the lateral heterostructure nanowires of the synthesized core-shell to synthesis longitudinal metal oxide heterostructure nanowires, and the step i) and ii) are performed repeatedly.

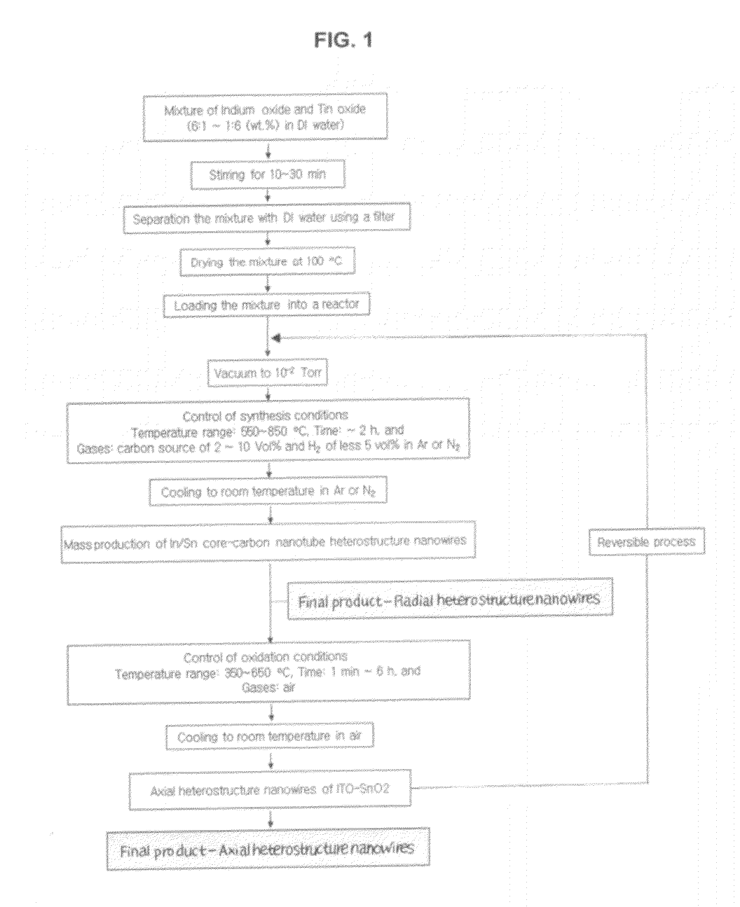

Referring now to FIG.1, the process for forming heterostructure nanowires are described in detail. First, lateral heterostructure nanowires based on a graphitic shell is synthesized to synthesize a longitudinal heterostructure nanowires comprised of at least two kinds of substances in its growth direction.

A metal oxides served as catalyst that can produce graphitic shell to synthesize lateral heterostructure nanowires based on graphitic shell should be prepared, wherein, the choice of meta oxidel is made according to whether the product generated after the metal oxide is reduced has a catalytic activity adapted to synthesize carbon. Even if there is various metal oxides having a catalyst activity, indium oxide and tin oxide are described for clear description in the embodiments described below,

First, the prepared indium oxide and tin oxide are soaked in distilled water. At this point, the rate of tin oxide to indium oxide is regulated in the range of 6:1˜1:6 based on a weight rate, and the weight of the entire mixture of metal oxides in the distilled water is regulated within 10 wt % of the distilled water weight.

So aqueous solution of prepared metal oxides is uniformly mixed using a magnetic bar rotating at 200 rpm for 10˜30 minute and then only the metal oxide particles is selectively recovered using cellulose filter with pores of 200 nm size filled with an uniformly maxed oxide aqueous.

Next, the recovered metal oxide is placed in the oven set at 100° C. and is dried to completely remove the residual moisture in the surface of the recovered metal oxide, so a preparation of metal oxide mixture for synthesizing heterostructure nanowires is finished.

And then a quartz boat is filled with dried metal oxide mixture to synthesize heterostructure nanowires from next prepared metal oxide and then the mixture is placed in a inner portion of a prepared reactor and a degree vacuum of internal reactor is decreased to a maximum 10⁻² Torr while removing all a residual oxygen prior to a start of synthesis.

When a vacuum work is finished, a vacuum pump is turn off, and a temperature of a reactor is increased to the rang of 550˜850° C. adapted to a synthesis while a gas such as argon or nitrogen serving as a carrier gas is supplied.

When the temperature of a reactor is increased to a synthesis temperature, hydrocarbon gas which is carbon source is provided. Any one or more than two of acetylene, methane and ethylene may be used as hydrocarbon gas, and the amount of hydrocarbon flowing into the reactor is preferably in the range of 2˜10 vol %. The supplied gas is first decomposed into carbon and hydrogen on the surface of metal oxide particles positioned in the boat of the inner portion of the reactor.

At this time, the decomposed hydrogen element serves to reduce metal oxide such as indium oxide and tin oxide. That is, in process that indium oxide and tin oxide are gradually reduced as metal indium and metal tin from the surface, resulting in the production of alloy of indium and tin or intermetallic nanoparticles.

This is possible because the melting point of indium and tin which is in 153° C. and 231° C., and eutectic temperature of their alloy is below 200° C., or so is lower than synthesis temperature of 550˜850° C. Nanoparticles comprised of reduced indium and tin serve to perform catalyst role forming graphitic shell that is, crystallized carbon structure having carbon atoms decomposed by catalyst reaction therein.

In this process, graphitic shell may act as one container and continue to be formed and indium/tin solution form nanowires while being continued to move along graphitic shell.

As a result, such a growth mechanism enables to form heterostructure involving intermetallic or alloys core filled with indium and tin therein and graphitic shell. At this time, the synthesis time is preferably performed up to 2 hours.

On the other hand, in the synthesis process, small quantities of hydrogen may be added into a reactor to more prompt the reduction of metal oxide and to suppress a generation of amorphous carbon.

If hydrogen is too many, the reduction of metal oxide is too fast and therefore, the production of intermetallic or alloy of indium and tin is too precipitated.

Therefore, heterostructure nanowires become too large in size and synthetic yield of hetero nanowires can be degraded, whereby the supply amount of hydrogen is preferably 0˜5 Vol %.

When this synthesis is finished, the temperature of a rector is cooled to a room temperature under a carrier gas atmosphere and then lateral heterostructure nanowires based graphitic shell produced is obtained. In this way, the synthesis of lateral heterostructure nanowires comprised of graphitic shell and indium/tin core is primarily finished.

As a result, it can be confirmed that lateral heterostructure nanowires having to indium/tin and graphitic shell synthesized by the present application is 50˜150 nm in a diameter, thickness of graphitic shell is 1˜20 nm and the length is 1˜10 μm.

The lateral core-shell heterostructure nanowires obtained after this is placed into quartz or aluminum boat and the oxidation process is started.

The oxidation temperature is preferably 350˜650° C., in which the most of substance used as core in graphitic shell can be converted into metal oxides.

The rise of temperature is preferably 1˜10° C./min, in which the abrupt temperature rise allows an abrupt incineration of graphitic shell and the oxidation speed of core substance to be too fast, and thus cannot keep a desirable type of nanowires.

The time of the oxidation processing is performed in range of 1 minute˜6 hours and the heat processing atmosphere gas is preformed in a general air atmosphere, thereby making it to provide an additional air. When the oxidation process is finished, in case the temperature of reactor is cooled to a room temperature and the sample is obtained, the synthesis of longitudinal ITO-tin oxide heterostructure nanowires is finished.

The lateral heterostructure nanowires are incinerated by the reaction with oxygen through the above-mentioned oxidation processing. The incineration speed may be controlled based on a temperature rising rate of reactor, and an oxidation reaction processing time and an oxygen density control, which is a very important control factor.

An intermetallics or alloy of indium/tin in graphitic shell is in solution, which is converted into oxides by contacting with oxygen along with progressive incineration of graphitic shell.

In this process, an intermetallics or alloy of indium/tin again is divided into two. Two oxides are maintained in form of nanowires and thus longitudinal ITO-tin oxide heterostructure nanowires are synthesized.

It can be confirmed that longitudinal ITO-tin oxide heterostructure nanowires are in the range of 50˜150 nm in a average diameter, is formed preferably in 100 nm and the length is 1-10 μm.

In addition, longitudinal ITO-tin oxide heterostructure nanowires can be again converted into the lateral heterostructure nanowires comprised of an intermetallics or a alloy core-graphitic shell using a above-mentioned supply method. Therefore, it can be shown that the reversible synthesis between graphitic shell-intermetallics or alloys core heterostructure nanowires and longitudinal ITO-tin oxide heterostructure nanowires become possible.

As described below, an embodiment will be described in regard to the synthesis method for graphitic shell-alloys core heterostructure nanowires and longitudinal metal oxide nanowires. However, the scope of the present invention is not limited to the preferable embodiment, and those skilled in the art will be appreciated to understand various modified form of disclosure described in the specification.

### [Embodiment 1] XRD Graph for Lateral Heterostructure Nanowires Produced According to Weight Rate of Tin Oxide and Indium Oxide

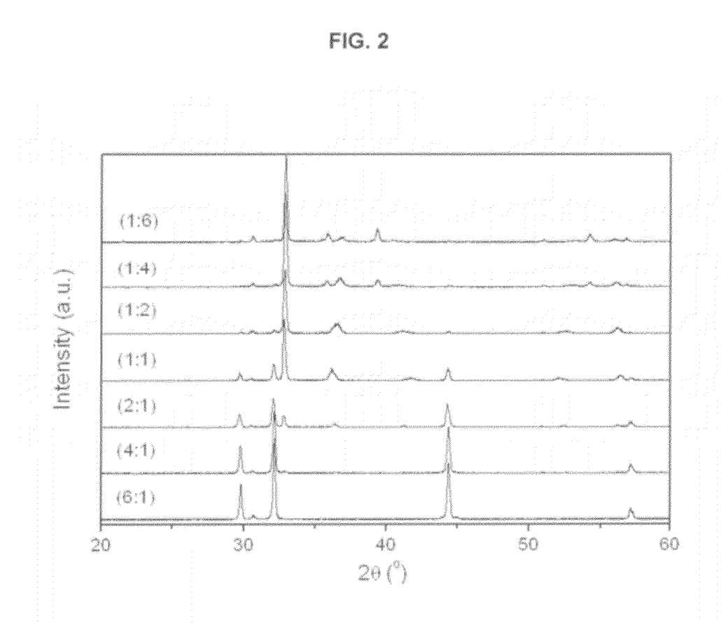

FIG. 2 shows XRD graph for lateral heterostructure nanowires having indium/tin intermetallic core and graphitic shell in accordance with the present application

The difference for heterostructure nanowires produced according to a weight rate of tin oxide and indium oxide in the embodiment was interpreted using XRD analysis.

It can be confirmed that if tin oxide:indium oxide is 6:1, intermetallics of InSn₄ composed of the rate that tin is 4 and indium is 1 is produced.

It could be confirmed that as the rate of indium oxide in mixture of tin oxide and indium oxide increase, a intermetallics of In₃Sn composed of the rate that tin is 1 and indium 3, along with InSn₄ is produced, and it could be shown that if tin oxide; indium oxide is 1:6, indium/tin core is positioned in the inner portion of graphitic shell appears mostly as In₃Sn.

### [Embodiment 2] SEM Image According Synthesis Temperature

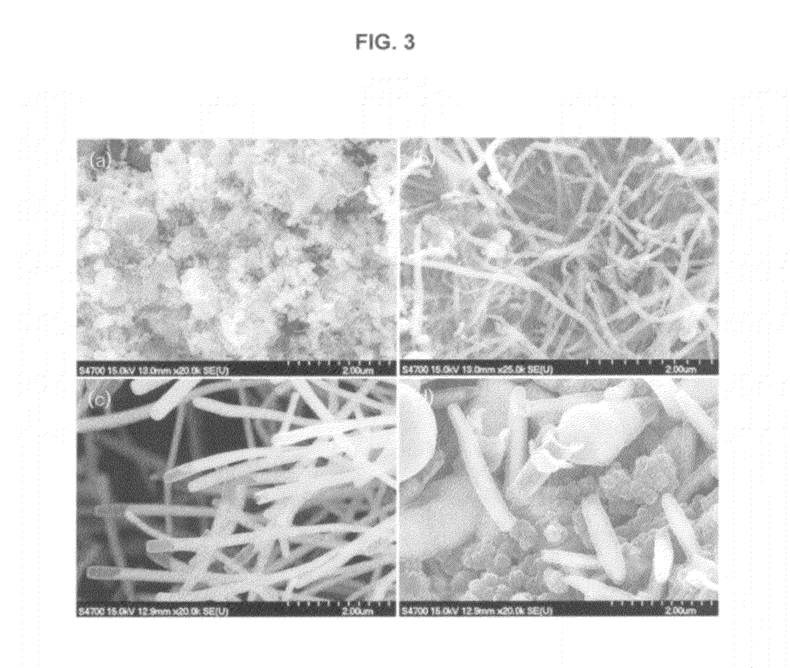

FIG. 3 shows SEM image according to the synthesis temperature of lateral heterostructure nanowires having indium/tin intermetallic core and graphitic shell in accordance with the present application, in which (a), (b), (c) and (d) illustrate SEM image for heterostructure nanowires synthesized at 550, 650, 750 and 850° C., respectively.

It was confirmed that heterostructure nanowires are partially produced at 550° C. of the synthesis and, it could be known that a synthesis yield of heterostructure nanowires are increased considerably. Such a tendency was appear as more remarkable phenomenon.

In particular, it can be confirmed that graphitic shell surrounding indium/tin core which is contained in the inner portion thereof and the outer portion is clearly exist.

However, if the synthesis temperature is increased to 850° C., it could be confirmed that a yield of heterostructure nanowires decreased, whereas, a diameter of heterostructure nanowires considerably increased. Finally, it was confirmed that a diameter of heterostructure nanowire increased according to increase of synthesis temperature and the highest yield is favorably obtained at 650˜750° C.

### [Embodiment 3] SEN Image for Core-Shell Heterostructure Nanowires Produced According to Synthesis Time

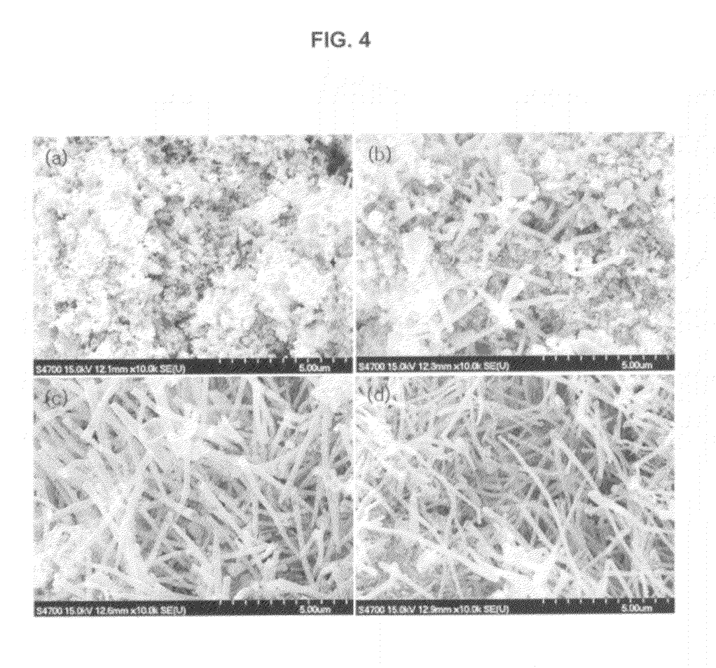

FIG. 4 shows SEM image according to synthesis time of heterostructure nanowires having indium/tin intermetallic core and graphitic shell in accordance with the present application, in which (a), (b), (c) and (d) illustrate SEM image for heterostructure nanowires synthesized at 1, 5, 10 and 60 minute, respectively.

It was confirmed that the product synthesized for 1 minute exist as particle phase and it was appeared that these particles are mixed with indium oxide and tin oxide which is not reduced yet, partially reduced indium and tin as well as alloy of indium/tin.

If a synthesis time is increased to 5 minute, the appearance was partially observed, and the produced nanowires are short yet and the yield is less and particles that is considered as indium oxide and tin oxide which is not reduced yet, partially reduced indium and tin as well as alloy of indium/tin were observed.

If a synthesis time is increased to 10 minute, it was observed that hetero structure nanowires are at most of surface, the existence of indium oxide and tin oxide was confirmed as a minute amount, and what indium oxide and tin oxide are converted into indium/tin intermetallics nanowires was almost observed using SEM image.

Such a result is supported by XRD graph for associated product. It was confirmed that the length of produced heterostructure nanowires is above 5 μm.

### [Embodiment 4] TEM Image of the Produced Core-Shell Heterostructure Nanowires

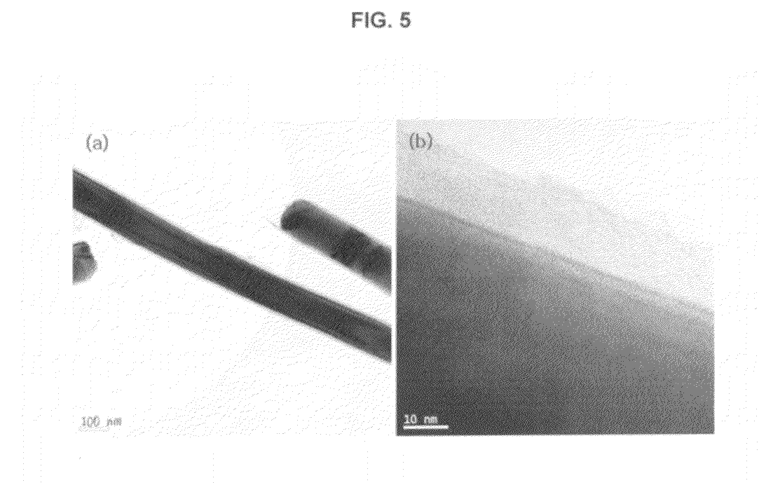

FIG. 5 shows TEM image according to the synthesis time of heterostructure nanowires having indium/tin intermetallic core and graphitic shell in accordance with the present application

(a) is a low magnification image of the heterostructure nanowires, in which it was confirmed that a core is enclosed by graphitic shell and it was confirmed that core/tin core within graphitic shell is filled above 90%:

It was confirmed that the lattice structure of core included through a high magnification TEM image (b) is intermetallics of indium/tin

And, it was confirmed that this is InSn₄ or In₃SN depending on mixture rate of tin oxide and indium oxide as shown in FIG. 2. In addition, lattice spacing of the core was calculated to 0.34 nm.

### [Embodiment 5] Component Analysis for the Produced Core-Shell Heterostructure Nanowires

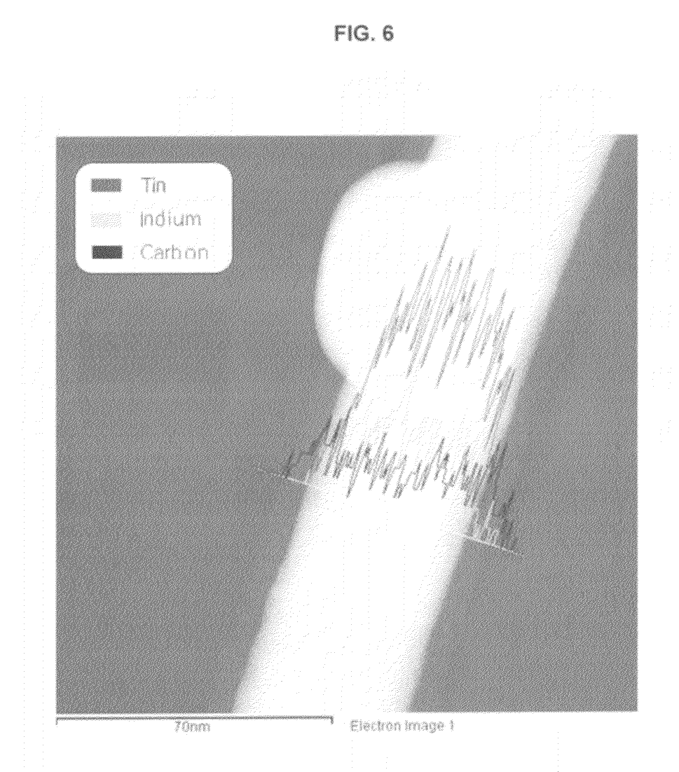

FIG. 6 shows the element analysis of heterostructure nanowires having indium/tin intermetallic core and graphitic shell in accordance with the present application.

As shown in the drawing, it was conformed that component of shell is carbon and the core that is contained in the inner portion of the shell is component containing indium and tin.

It was confirmed that because such a result completely corresponds to the above mentioned TEM image, the shell of heterostructure nanowires is a nanotube that resembles CNT, and the core is the intermetallics comprised of indium and tin.

The heterostructure nanowires shown in drawing of the embodiment was confirmed that InSn₄ intermetallics contained at the rate that indium is 1 and tin is 4 is produced as a core.

### [Embodiment 6] XRD Graph for Longitudinal ITO-Tin Oxide Heterostructure Nanowires

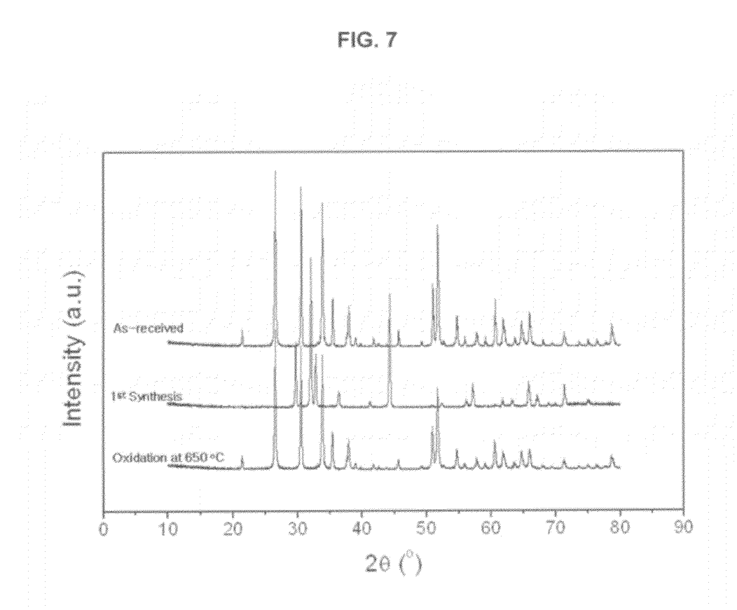

FIG. 7 shows XRD graph for longitudinal. ITO-tin oxide heterostructure nanowires in the present invention.

As-received illustrates XRD graphy for a mixture of indium oxide and tin oxide, and 1ₛₜ synthesis is a XRD graph obtained by reacting the mixture of indium oxide and tin oxide with acetylene at 750° C. for 1 hour, It can be confirmed from InSn₄ and In₃Sn which the intermetallics are produced in the graph.

It can be confirmed that the graphitics shell is fully removed by the oxidation processing for the produced indium/tin core-graphitic shell heterostructure nanowires at 650° C. and it can be confirmed that the oxidized product is crystal structure that is similar to that of indium oxide and tin oxide of As-received which is original sample. Specifically, it can be confirmed that ITO that tin oxide is partially contained in indium oxide.

### [Embodiment 7] SEM Image for the Produced Longitudinal ITO-Tin Oxide Heterostructure Nanowires

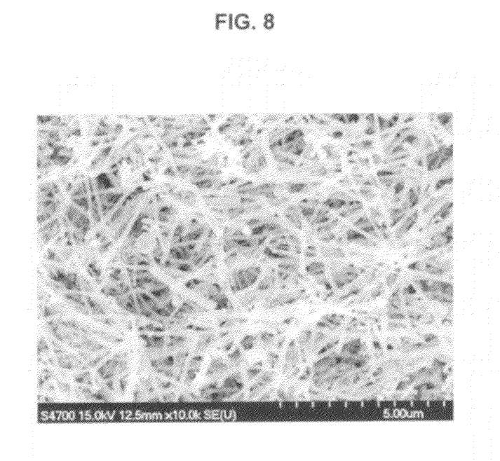

FIG. 8 shows SEM image for longitudinal ITO-tin oxide heterostructure nanowires obtained using oxidation process of lateral heterostructure nanowires having indium/tin core and graphitic shell in accordance with the present invention.

The drawing illustrates the longitudinal ITO-tin oxide heterostructure nanowires obtained from the oxidation treatment for the primarily synthesized lateral heterostructure nanowires. Even if the its size look similar to the primarily synthesized core-shell heterostructure nanowires at 650° C., the its presence was not conformed and it was observed that some nano particle is partially on the surface of the nanowire. In addition, it was also observed that the boundary layer is in the middle of the middle.

### [Embodiment 8] TEM Image for Produced Indium/Tin Mixture—Tin Oxide Hetero Nanowires

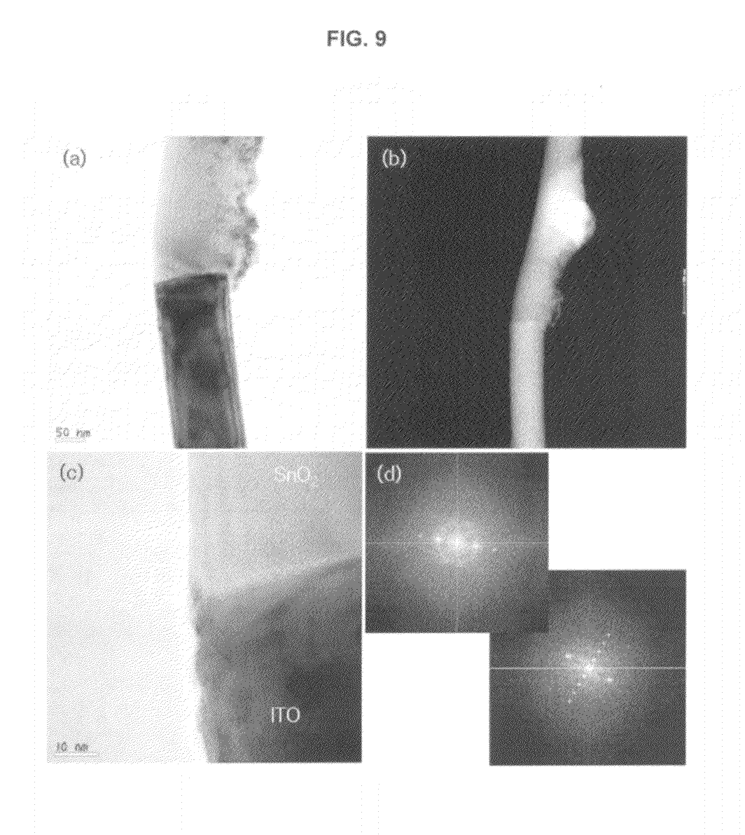

FIG. 9 shows TEM image for a longitudinal ITO-tin oxide heterostructure nanowires.

(a) illustrates a low magnification of longitudinal ITO-tin oxide heterostructure nanowires produced by the oxidation treatment of the lateral heterostructure nanowires at 650° C., where, the graphitic shell is not observed in its outer portion, and it was confirmed that the layer in which the substance having a different contrast in the middle of nanowires generate is formed.

STEM image of (b) shows clearly such the difference in a contrast. Since a difference in contrast has an different specific gravity for each substance, it was confirmed in the structure in which the different substance is connected each other. (c) is the image for the high magnification of (a) and, (d) shows XRD diffraction pattern for an upper end and an lower end based on the boundary of (c). According to the analysis for each diffraction pattern, it was clearly confirmed that the lower end is ITO and the upper end is tin oxide.

### [Embodiment 9] EXD Analysis for the Produced Longitudinal ITO-Tin Oxide Heterostructure Nanowires

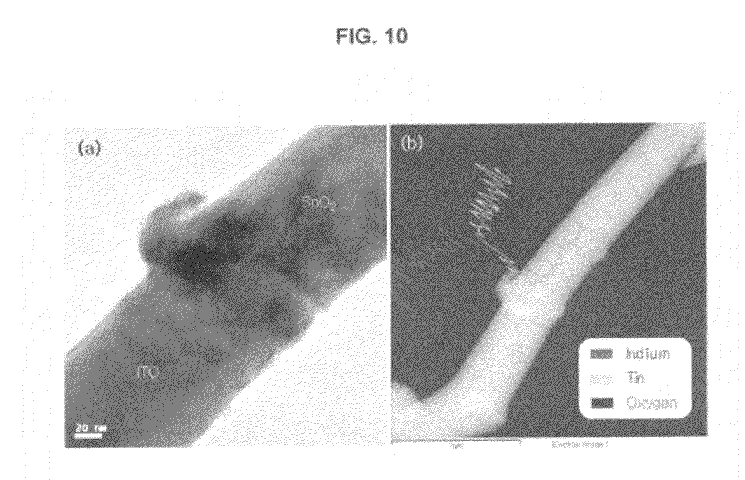

FIG. 10 shows the line element profile of longitudinal ITO-tin oxide heterostructure nanowires.

(a) is TEM image, in which the boundary was confirmed in the middle of nanowires, and drawing (b) shows the line profile for STEM image of (a) and the associated component, confirmed that there is indium, tin, and oxygen in the lower end and tin and oxygen in the upper. This can confirm that ITO is formed in the lower end and tin oxide is formed in the upper end.

### [Embodiment 10] STEM and Mapping for the Produced Longitudinal ITO-Tin Oxide Heterostructure Nanowires

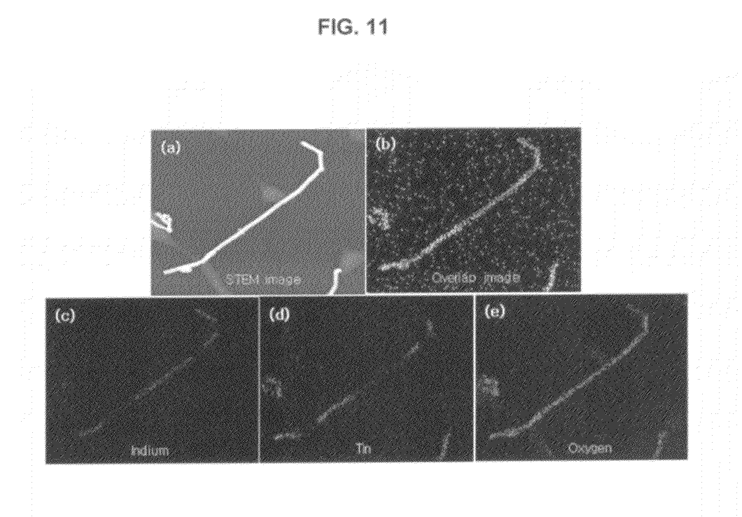

FIG. 11 shows Mapping image for longitudinal ITO-tin oxide heterostructure nanowires.

One nanowire can be observed in the STEM image, wherein the mapping image of the entire components relative to thereof is shown in Drawing (c) to (e). (c) is indium, (d) is tin, and (e) is oxygen component.

As a result, oxygen was confirmed in the whole portion of nanowire for analysis. However, it was confirmed that there are indium and tin along the longitudinal direction. Especially, the small amount of tin was detected.

Such a result could clearly confirm in the overlay area (c). This clearly shows that the produced nanowires are ITO-tin oxide heterostructure nanowires formed in longitudinal direction.

### [Embodiment 11] In-Suit XRD for Longitudinal ITO-Tin Oxide Heterostructure Nanowires Obtained Finally using Oxidation Treatment of the Lateral Heterostructure Nanowires having Indium/Tin Core and Graphitic Shell

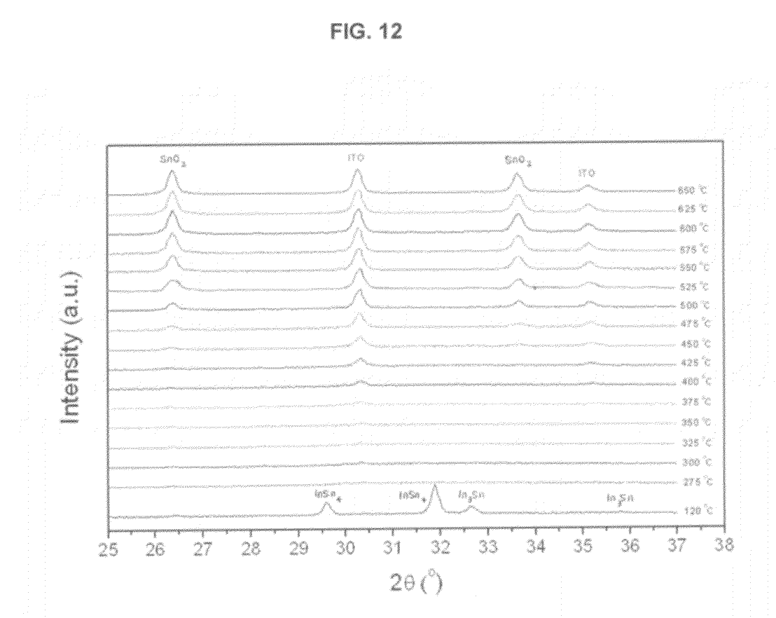

FIG. 12 shows In-situ XRD analysis result of longitudinal ITO-tin oxide heterostructure nanowires finally obtained using oxidation process of the lateral heterostructure nanowires having indium/tin core and graphitic shell in accordance with the present invention.

It be should noted that the measurement was made while the temperature increases from 20° C. to 650° C.

In up to 120° C., IN₃Sn and InSn₄ relative to intermetallics of indium and tin was observed. However, in more than 120 to 350° C., No the phase was found. This means that intermetallics of indium and tin are at liquid state. In actual, there is the melting point of intermetallics of indium and tin according to the component at 120 to 220° C. After this, from 350° C., the phase relative to indium oxide and tin mixture was observed at first, and it was confirmed that as the temperature approaches to 650° C., the phase appears more greater. This shows that intermetallics of indium and tin of the liquid phase in graphitic shell is converted gradually into the metal oxide form.

### [Embodiment 12] In-Situ Raman for Longitudinal ITO-Tin Oxide Heterostructure Nanowires Finally Obtained using Oxidation Process of the Lateral Heterostructure Nanowires having Indium/Tin Core and Graphitic Shell

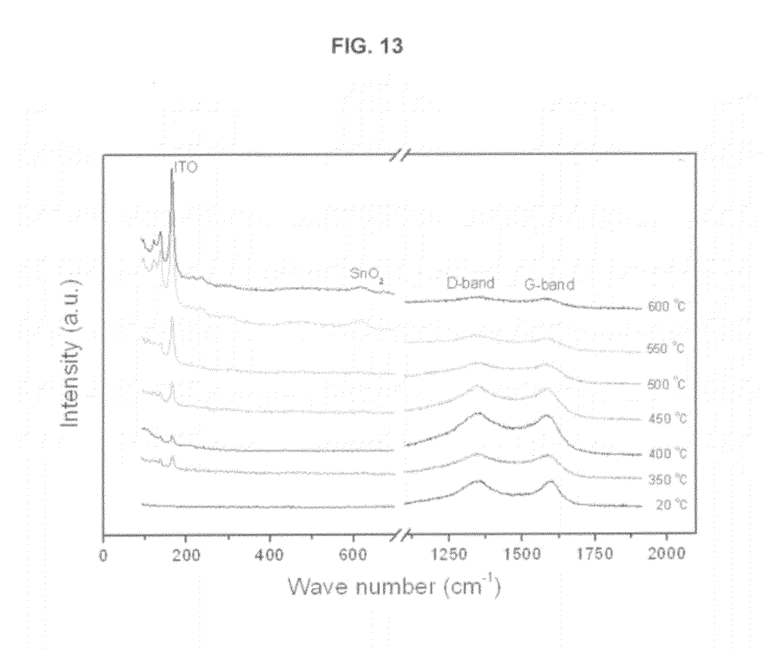

FIG. 13 shows In-situ Raman analysis for longitudinal ITO-tin oxide heterostructure nanowires finally obtained using oxidation process of the lateral heterostructure nanowires having indium/tin core and graphitic shell in accordance with the present invention.

It be should noted that the measurement was made while the temperature increases from 20 to 600° C.

The Raman spectra show that of the same result of XRD. Only D-band and G-band related to graphitic shell was confirmed in Raman spectra of the low temperature. In actual, the intermetallics of indium and tin were not exited. Therefore, it is natural that such result was derived between intermetallic core of indium and tin, and core-shell heterostructure nanowires. However, D-band and G band corresponding to graphitic shell gradually disappears as increase of temperature, and peaks of the metal oxide related to tin and indium were found. Especially, The most significant measured peck at 150 to 200 cm⁻¹ among especially indium related peaks shows a shape in which is confirmed in ITO that a small amount of tin is mixed with indium oxide. These results shows that the lateral heterostructure nanowire having indium/tin core and graphitic shell using oxidation process of the high temperature can be converted into longitudinal ITO-tin oxide heterostructure nanowires.

### [Embodiment 13] Superconducting Properties Analysis for the Produced Lateral Heterostructure Nanowires

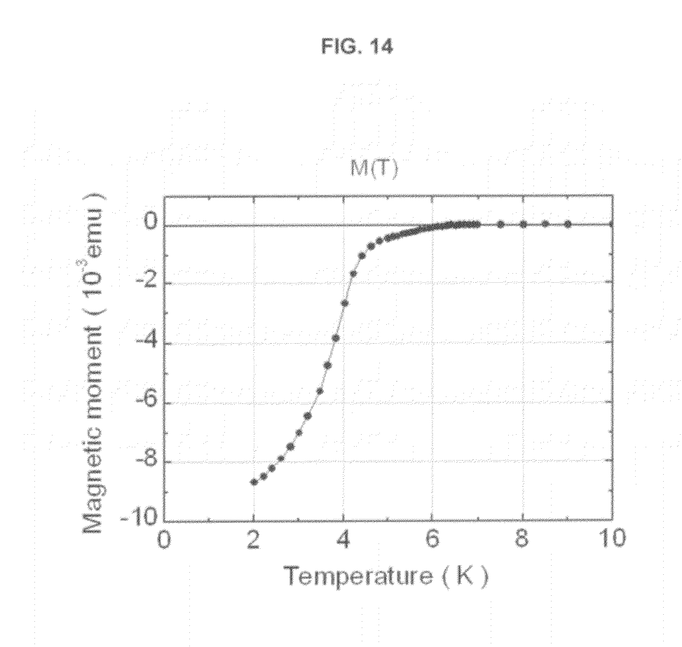

FIG. 14 shows the result of superconducting properties analysis of the lateral heterostructure nanowires having indium/tin core and graphitic shell in accordance with the present invention.

In FIG. 14, it was conformed that the magnetization characteristic according to the temperature of the produced lateral heterostructure nanowires shows the same tendency as the superconductor characteristic. In addition, the bulk superconductor temperature was determined at 4.8˜6.0 K, and it was conformed that this is higher than the superconductor temperature of pure tin (T_{c}=3.7K). It was confirmed that the different superconductor temperature is shown according to the rate of indium and tin of heterostructure nanowires having such indium/tin core.

In view the above-mentioned results, heterostructure nanowires produced according to the present invention may be utilized as a useful superconductor material.

### [Embodiment 14] Lateral Heterostructure Nanowires Synthesis using Bismuth Oxide and Tin Oxide

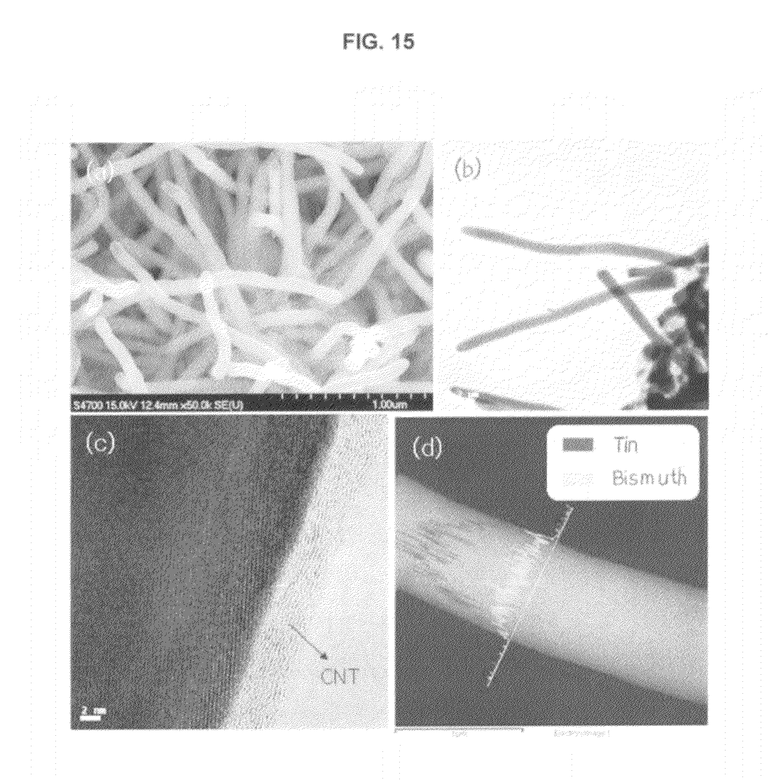

FIG. 15 shows lateral heterostructure nanowires having bismuth/tin core and graphitic shell synthesized in the same manner as the present invention.

The synthesis method was performed as described in the above embodiments and FIG. 1.

(a) shows SEM image for lateral heterostructure nanowires having produced bismuth/tin core and graphitic shell.

The synthesized form is similar to indium/tin core-graphitic shell heterostructure nanowires, and it was confirmed that bismuth/tin core is contained above 90% in the inside of graphiticl.

A low magnification and a high magnification TEM images (b) and (c) of the synthesized lateral heterostructure nanowires, and component analysis (d) clearly was shown that synthesized heterostructure nanowires are made of bismuth/tin alloy in the inner space of graphitics shell.

### [Embodiment 15] The CL Measurement Result for Longitudinal ITO-Tin Oxide Heterostructure Nanowires

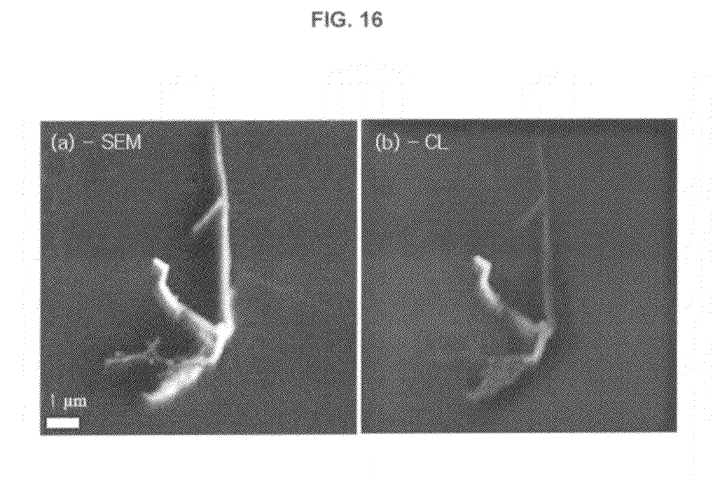

FIG. 16 shows measurement result of CL (cathodoluminescence) of longitudinal ITO-tin oxide heterostructure nanowires

It was shown that the SEM image of (a) has the longitudinal ITO-tin oxide heterostructure nanowires. The difference in brightness was partially observed clearly in view of the measured result of CL characteristic for such heterostructure nanowires. This also shows a portion of ITO in which the energy bandgap is relatively large looks brighter than in the part of tin oxide. Therefore, it is demonstrated that the nanowires are longitudinal ITO-tin oxide heterostructure nanowires.

### [Embodiment 16] Reversible Synthesis to Lateral Heterostructure Nanowires having Indium/Tin Core and Graphitic Shell of Longitudinal ITO-Tin Oxide Heterostructure Nanowires

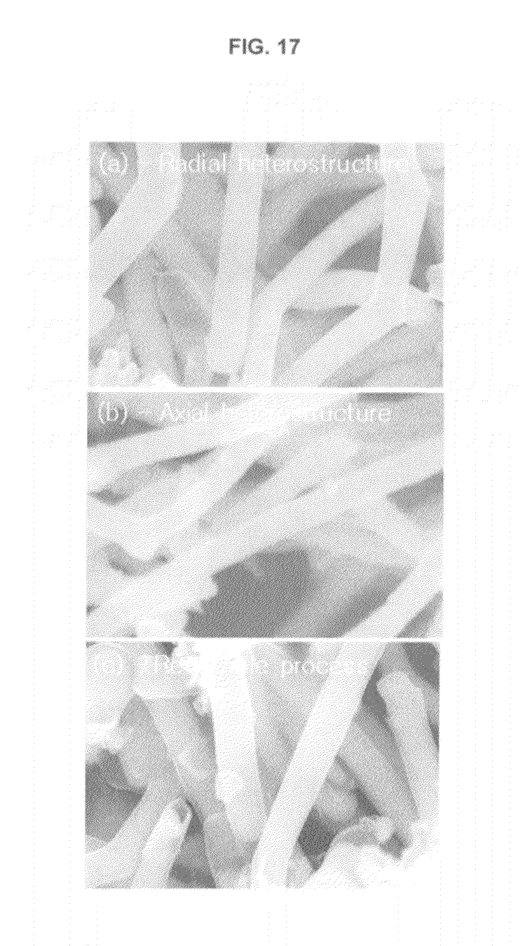

FIG. 17 shows SEM image for reversible synthesis to lateral heterostructure nanowires having indium/tin core and graphitic shell of longitudinal ITO-tin oxide heterostructure nanowires.

(a) shows the lateral heterostructure nanowires having indium/tin core and graphitics shell synthesized through the primarily synthesized core-shell hetero structure nanowires synthesis process. (b) shows the longitudinal ITO-tin oxide heterostructure nanowires synthesized through 650° oxidation process for the primarily synthesized core-shell heterostructure nanowires and (c) shows the lateral heterostructure nanowires having indium/tin core and graphitic shell synthesized through the reversible process applicable again longitudinal ITO-tin oxide heterostructure nanowires to the primary core-shell heterostructure nanowires. As a result, it was confirmed that the lateral heterostructure nanowires having indium/tin core and graphitic shell and longitudinal ITO-tin oxide heterostructure nanowires make the reversible synthesis possible each other.

As described above, after synthesizing lateral heterostructure nanowires comprised of graphitic shell and intermetallics or alloy core as a medium of metal oxide mixture and oxdizes it to remove the graphitic shell on the surface and oxidizes and separates intermetallics or alloy to synthesize the novel type of longitudinal metal oxide heterostructure wires.

Using such principle, the lateral heterostructure nanowires are synthesized using simultaneously the various substance and longitudinal heterostructure nanowires containing various substance can be produced in volume as a very simple process.

While the described embodiment represents the preferred form of the prevent invention, it is to be understood that modifications will occur to those skilled in the art without departing from the sprite of the invention.

1. A synthesis method of lateral heterostructure nanowires containing alloy core and graphitic shell, the method comprising:
i) a step for preparing a metal oxide mixture, installing it into a reactor, and supplying a carrier gas under a vacuum atmosphere to increase internal temperature of the reactor to synthesis temperature; and
ii) a step for supplying hydrocarbon gas into the reactor and reacting the gas with the metal oxide mixture.

2. The synthesis method of claim 1, wherein:
the metal oxide mixture is a mixture of indium oxide and tin oxide, and the mixture rate of the indium oxide and tin oxide is 6:1˜1:6 based on a weight rate.

3. The synthesis method of claim 1, wherein:
hydrocarbon gas flowing into the reactor is a one or two more than mixtures selected from acetylene, ethylene and methane and the amount of hydrocarbon gas flowing into the reactor is in the range 2˜10 vol % based on the carrier gas.

4. The synthesis method of claim 1, wherein:
hydrogen gas is flown into the reactor to assist the reaction of the metal oxide mixture and hydrocarbon, and the inflow amount of the hydrogen gas is less than 5 vol %

5. The synthesis method of claim 1, wherein:
a reaction temperature of the metal mixture oxide and hydrocarbon gas is controlled in the range of 550˜850° C., and a reaction time is within 2 hours.

6. The synthesis method of claim 1, wherein:
the metal oxide mixture is a mixture of bismuth oxide and tin oxide.

7. The synthesis method of claim 1, wherein:
the alloy is intermetallics.

8. Lateral heterostructure nanowire containing alloy core and graphitic shell synthesized by the synthesis method of claim 1.

9. The lateral heterostructure nanowire of claim 8, wherein:
a superconducting critical temperature (T_{c}) is determined in the range of 4.8˜6.0 K.

10. The lateral heterostructure nanowire of claim 8, wherein:
the length of the whole diameter is formed 50˜150 nm.

11. The lateral heterostructure nanowire of claim 8, wherein:
the thickness of the shell is 1˜20 nm, and the length is 100 nm˜10 μm.

12. The lateral heterostructure nanowire of claim 8, wherein:
the alloy are filled more than 90% in the inner portion of the graphitic shell.

13. A synthesis method of a longitudinal heterostructure nanowires containing metal oxides along the longitudinal direction, the method comprising:
i) a step for preparing an metal oxide mixture, installing it into an reactor, and supplying an carrier gas under a vacuum atmosphere to increase the internal temperature of a reactor to an synthesis temperature;
ii) a step for supplying hydrocarbon gases into the reactor and reacting the gases with the metal oxide mixture to synthesize lateral heterostructure nanowires containing an alloy core and graphitic shell; and
iii) a step cooling the reactor to a room temperature, and increasing again the temperature under a oxide atmosphere to oxidize the lateral heterostructure nanowires.

14. The synthesis method of claim 13, wherein:
the metal oxide mixture is a mixture of indium oxide and tin oxide, and the mixture rate of the indium oxide and tin oxide is 6:1˜1:6 based on the weight rate.

15. The synthesis method of claim 13, wherein:
hydrocarbon gas flowing into the reactor is a one or two more than mixtures selected from acetylene, ethylene and methane and the amount of hydrocarbon gas flowing into the reactor is in the range 2˜10 vol % based on the carrier gas.

16. The synthesis method of claim 13, wherein:
hydrogen gas is flown into the reactor to assist the reaction of the metal oxide mixture with hydrocarbon gas, and a inflow amount of the hydrogen gas is 1˜5 vol % based on the carrier gas.

17. The synthesis method of claim 13, wherein:
a reaction temperature of the metal oxide mixture and hydrocarbon is controlled in the range of 550˜850° C., and a reaction time is within 2 hours.

18. The synthesis method of claim 13, wherein:
a oxidation processing temperature of the graphitic shell-alloy core hetero structure nanowires is controlled in the range of 350˜650° C., and a oxidation processing time is 1 minute˜6 hours.

19. The synthesis method of claim 13, wherein:
a temperature rise for oxidation processing of the graphitic shell-alloy core heterostructure nanowires is obtained at 1˜10° C./min.

20. The synthesis method of claim 13, wherein:
the metal oxide mixture is a mixture of bismuth oxide and tin oxide.

21. The synthesis method of claim 13, wherein:
the alloy is intermetallics.

22. A longitudinal metal oxide heterostructure nanowires synthesized by the synthesis method of claim 13.

23. The longitudinal metal oxide heterostructure nanowires of claim 22, wherein indium oxide/tin mixture containing tin of 0.01˜10% relative to indium oxide and tin oxide has an alternatively formed shape.

24. The longitudinal metal oxide heterostructure nanowires of claim 22, wherein the average diameter is formed in the range of 50˜150 nm.

25. The longitudinal metal oxide heterostructure nanowires of claim 22, wherein the length is 100 nm˜10 μm.

26. A reversible synthesis method between graphitic shell-alloy core heterostructure wires and longitudinal metal oxide heterostructure nanowires,
the method comprising:
i) a step for reacting metal oxide mixture and hydrocarbon gases within a reactor to synthesize lateral heterostructure nanowires having alloy core and graphitic shell, and
ii) a step for oxidizing lateral heterostructure nanowires of the synthesized core-shell to synthesis longitudinal metal oxide heterostructure nanowires,
and the step i) and ii) are performed repeatedly.

27. The reversible synthesis method of claim 26, wherein:
the metal oxide mixture is a mixture of indium oxide and tin oxide, and the mixture rate of the indium oxide and tin oxide is 6:1˜1:6 based on a weight rate.

28. The reversible synthesis method of claim 26, wherein:
hydrocarbon gas is a one or two more than mixtures selected from acetylene, ethylene and methane.

29. The reversible synthesis method of claim 26, wherein:
a reaction temperature of the metal oxide mixture and hydrocarbon gas is controlled in the range of 550˜850° C., and a reaction time is within 2 hours.

30. The reversible synthesis method of claim 26, wherein:
hydrogen gas is flown into the reactor to assist the reaction of the metal oxide mixture with hydrocarbon gas, and a inflow amount of the hydrogen gas is 1˜5 vol % based on the carrier gas.

31. The reversible synthesis method of claim 26, wherein:
a oxidation processing temperature of the graphitic graphitic shell-alloy core heterostructure nanowires is controlled in the range of 350˜650° C., and a oxidation processing time is 1 minute˜6 hours.

32. The reversible synthesis method of claim 26, wherein:
a temperature rise for oxidation processing of the graphitic shell-alloy core heterostructure nanowires is obtained at 1˜10° C./min.

33. The reversible synthesis method of claim 26, wherein:
the metal oxide mixture is a mixture of bismuth oxide and tin oxide.

34. The reversible synthesis method of claim 26, wherein:
the alloy is intermetallic.
